(19) United States
(12) Patent Application Publication
(10) Pub. No.: US 2015/0126662 A1
(43) Pub. Date: May 7, 2015

(54) SALT ADDITIVE TO PREVENT CLOGGING OF CARBOMER BASED HAND PRODUCTS

(71) Applicants: Shelby Buell, Medina, OH (US); Daniel M. Willis, Clinton, OH (US); John James McNulty, Broadview Heights, OH (US); Janice Lynn Moore, Aurora, OH (US); Touby Khamphilapanyo, Cuyahoga Falls, OH (US)

(72) Inventors: Shelby Buell, Medina, OH (US); Daniel M. Willis, Clinton, OH (US); John James McNulty, Broadview Heights, OH (US); Janice Lynn Moore, Aurora, OH (US); Touby Khamphilapanyo, Cuyahoga Falls, OH (US)

(21) Appl. No.: 14/534,700

(22) Filed: Nov. 6, 2014

Related U.S. Application Data
(60) Provisional application No. 61/900,580, filed on Nov. 6, 2013.

(51) Int. Cl. C08K 3/10; B29C 43/00; B29C 49/00; B29C 45/00

(52) U.S. Cl. CPC C08K 3/10; B29C 45/00; B29C 43/00; B29C 49/00; B29K 2101/00
USPC 524/401; 264/328.1; 264/325; 264/523

(57) ABSTRACT

The present invention is directed to dispensers, dispenser components and related methods for reducing or preventing sticking, drying, buildup, clogging, and/or misdirection of carbomer gel based products such as hand sanitizers by incorporating one or more salts, such as sodium chloride, as an additive to the polymer used to make certain pump and nozzle components of dispensers in such a way as to allow the salt crystals to access the polymer surface. The polymer/salt mixture is then formed into the desired dispenser component part by any conventional means, including without limitation, injection molding, compression molding, transfer molding, liquid injection molding, over molding, insert molding and/or blow molding.

### CROSS REFERENCE TO RELATED APPLICATIONS

This application claims the benefit of U.S. provisional patent application Ser. No. 61/900,580 entitled “Salt Additive to Prevent Clogging of Carbomer Based Hand Products,” filed Nov. 6, 2013, which is incorporated herein by reference in their entirety.

### FIELD OF THE INVENTION

The present invention generally relates to component parts for dispenser systems and pumping systems for use with fluids, particularly carbomer-based products such as hand sanitizers and lotions. In particular, the present invention is directed to polymer additives and related methods for use in dispenser components for reducing or preventing sticking, drying, buildup, clogging, and/or misdirection of carbomer based products such as hand sanitizers.

### BACKGROUND OF THE INVENTION

A recurring problem in the art of liquid dispensers has been the tendency for the outlet of the dispenser valve and other component parts to become clogged by the dried residue of the sanitizer, disinfectant, soap composition or other product that has been dispensed. A great many commercially available hand sanitizers, lotions, and foams use a cross-linked polyacrylic acid gel, generally referred to as “carbomer gel,” as a thickener and carrier and these carbomer gel based products are likewise prone to clogging, and/or misdirection of product as a result of the buildup of dried product residue and the dispenser nozzle, passage ways and/or pump.

These carbomer gel based products may be employed in any type of dispenser typically used for gel products, for example pump dispensers. A wide variety of pump dispensers are suitable. Pump dispensers may be affixed to bottles or other free-standing containers. Pump dispensers may be incorporated into wall-mounted dispensers. Pump dispensers may be activated manually by hand or foot pump, or may be automatically activated. Useful dispensers include those available from GOJO Industries under the designations NXT® and TFX™ as well as traditional bag-in-box dispensers. Examples of dispensers are described in U.S. Pat. Nos. 5,265,772, 5,944,227, 6,877,642, 7,028,861, 8,714,853 and U.S. Published Application Nos. 2006/0243740 A1 and 2006/0124662 A1, all of which are incorporated herein by reference in their entirety. In one or more embodiments, the dispenser includes an outlet such as a nozzle, through which the carbomer gel based product is dispensed.

Dispensers known in the art for use with carbomer gel based products such as hand sanitizers typically comprise a reservoir for holding and storing the product, a passageway from the reservoir to a pumping mechanism having a valve and a passageway or channel from the pumping mechanism to an outlet/nozzle. The dispensing channels on the outlet side of the valve in such dispensers can be of considerable length, and the outlet/nozzle from which the fluid is dispensed ordinarily remains open (e.g., unsealed) between uses so that undispensed product remains in the channel near the dispenser outlet.

By nature, the carbomer gel in these products has an adhesive quality and the flow pathways that are exposed to the environment will tend to collect residual carbomer gel on their surfaces. As the volatile substances (mostly water and alcohol) in the product evaporate into the environment, the remaining non-volatile components, such as the carbomer gel, humectants, emollients, silicones, and/or surfactants that are a solid at room temperature, will tend to concentrate into a dried or highly viscous residue. This often results in the formation of a viscous, semi-solid, or solid plug formed in the dispenser pump or in the dispensing channels of the dispenser most often around and/or within the nozzle tip.

This creates a series of significant problems. For example, when the dispenser is next used, the plug can prevent dispensable product from being dispensed or it can temporarily hamper the proper flow of dispensable product from the dispenser until enough pressure builds behind the plug to force it out of the flow outlet, often resulting in dispensable product spurting out of the tip in a directionally random manner under significant force. Moreover, dried residue that is left at or near the opening of a dispenser valve is unsightly and may attract potential contaminants between uses of the dispenser.

Although attempts have been made to remedy the problem of clogging, the proposed remedies have often involved the use of intricate and sometimes complex mechanical modifications to the dispenser to prevent residue from collecting and drying around the dispenser orifice. One such approach has been to try to remove residual product from the nozzle or other important parts of the dispenser before the residual product can have a chance to dry. In some cases, fluid pathways are designed to pull fluid away from the nozzle opening by using capillary action. In other cases, the residual product is fed away from the nozzle by channels or suctioned away. Other approaches have focused on the use of nozzle materials having a low surface energy to decrease wettability of the surface and reduce the amount of fluid left to form a residue on the surfaces. These approaches have generally involved impregnating or coating certain dispenser parts with substances such as silicone to prevent the product from adhering or sticking the internal surfaces of some, or all, of the dispenser. Other methods have involved various mechanical self-cleaning mechanisms.

Approaches that depend upon reduced wettability materials have not proved effective for non-clogging nozzles where carbomer gels are used, as residual build up still occurs. Carbomer gels are often too viscous for any significant capillary action to be useful in removing gelled products from the nozzle openings. Likewise, systems that apply a “suck-back” feature; either by use of a floating shuttle valve or by a secondary source of vacuum have also been ineffective. All of these solutions to the problem still leave nozzle channels coated with carbomer gel. Similar to the way a candle is made by dipping a wick into melted wax, allowing it to cool, and then re-dipping it until the candle is made, carbomer residue can build up within nozzles and channels that have been cleared by use of a “suck-back” feature, eventually leading to full or partially clogged nozzles.

Some other mechanical approaches to the problem often require the direct manipulation of a rotating cap or a spring loaded nozzle cover in order to minimize evaporation at the nozzle, to “clean” or scrape residual product away from nozzle, and to open the nozzle flow path. When the actuation motion for a dispensing system is indirect and far removed from the nozzle, these solutions become less satisfactory. Either a secondary action is required of the end user (rotating a nozzle cap), or a complex mechanism is needed to carry the actuation force to the nozzle cap/cleaner. These mechanisms add cost and decrease the reliability of the dispensing system and degrade the life of any energy source used to dispense the product and/or increase the amount of force required for the user to actuate the system manually.

The effect of salt (e.g. sodium chloride) on carbomer gels is well known in the art. Before contact with water, cross-linked polyacrylic acid (carbomer) is tightly coiled and in the form of a powder. Once it is becomes hydrated by mixing in water the cross linked polyacrylic acid begins uncoiling. To form the gel, the mixture is then neutralized with a base, creating negative charges (carboxyl groups) along the backbone of the polymer. Since the negative charges are repulsive, the polymer uncoils further into an extended polymer, thickening the product. The addition of salt is known to return the carbomer to its liquid form. As electrolyte concentration from the salt dissolving into the gelled solution goes up, it can bridge the repulsive forces between the carboxylic acid groups and allow the polymer to collapse on itself, thereby breaking the gel form.

What is needed in the art are dispenser components incorporating a polymer/salt mixture that substantially reduces or prevents sticking, drying, buildup, clogging, and/or misdirection of carbomer based gel products.

### SUMMARY OF THE INVENTION

The present invention is directed to dispenser components and related methods for reducing or preventing sticking, drying, buildup, clogging, and/or misdirection of carbomer gel based products such as hand sanitizers by incorporating one or more salts, such as sodium chloride, as an additive to the polymer used to make certain pump and nozzle components of dispensers in such a way as to allow the salt crystals to access the polymer surface. The polymer/salt mixture is then formed into the desired dispenser component part by any conventional means, including without limitation, injection molding, compression molding, transfer molding, liquid injection molding, and/or blow molding.

When the solution contacts the salted polymer surface, the electrolytic activity of the salt significantly reduces the viscosity of the gel at the interface between the aliquot of fluid and the salted polymer pathway surfaces. It is believed that the salt leaves the component part and dissolves into the carbomer solution. As electrolyte concentration from the salt goes up, it can bridge the repulsive forces between the carboxylic acid groups and allow the polymer to collapse on itself, thereby breaking the gel form. This has the result of substantially reducing the viscosity of the gel form at the surface to fluid interface, thereby reducing the amount of residue that can collect on the surface. This reduction of residue significantly lowers the risks associated with the sticking, drying, buildup, clogging, and/or misdirection of the product.

In a first aspect, the present invention provides a dispenser component configured for use in a dispenser for carbomer gel based compositions, the dispenser component comprising: at least one surface configured to be in contact with the carbomer gel based composition when it is being dispensed, and a plurality of salt crystals located on or in communication with the surface. In one or more embodiments, of this aspect of the present invention some or all of the dispenser component comprises a polymer/salt mixture. In some embodiments, the dispenser component may comprise: a thermoplastic polymer, thermoset polymer or reaction polymer; and a salt selected from the group consisting of sodium chloride, potassium chloride, calcium chloride, and combinations thereof; wherein the thermoplastic polymer, thermoset polymer or reaction polymer and the salt form a polymer/salt mixture and at least some of the salt is on or in communication with the surface of the polymer/salt mixture.

In one or more embodiments, the dispenser component may include, without limitation, any one or more embodiments of the first aspect of the present invention described above wherein the polymer further comprises a thermoplastic polymer, thermoset polymer or reaction polymer. In one or more embodiments, the dispenser component may include, without limitation, any one or more embodiments of the first aspect of the present invention described above wherein the polymer is selected from the group consisting of acrylonitrile butadiene styrene (ABS), polypropylene (PP), high-density polyethylene (HDPE), polyethylene (PE), low-density polyethylene (LDPE), Nylon® (PA), polycarbonate (PC), polyethylene terephthalate (PET), high-impact polystyrene (HIPS), urethane, Santoprene®, silicone, polyurethane, and combinations thereof.

In one or more embodiments, the dispenser component may include, without limitation, any one or more embodiments of the first aspect of the present invention described above wherein the plurality salt crystals are selected from the group consisting of sodium chloride, potassium chloride, calcium chloride, and combinations thereof. In one or more embodiments, the dispenser component may include, without limitation, any one or more embodiments of the first aspect of the present invention described above wherein the salt in the polymer/salt mixture is selected from the group consisting of sodium chloride, potassium chloride, calcium chloride, and combinations thereof. In one or more embodiments, the dispenser component may include, without limitation, any one or more embodiments of the first aspect of the present invention wherein the polymer/salt mixture contains from about 5% to about 25% salt by weight.

In one or more embodiments, the dispenser component may include, without limitation, any one or more embodiments of the first aspect of the present invention set forth above wherein the dispenser component is selected from the group consisting of nozzles, pump components, guards, and combinations thereof. In one or more embodiments, the dispenser component may include, without limitation, any one or more embodiments of the first aspect of the present invention set forth above wherein the dispenser component is a nozzle for use with a carbomer gel based composition.

In a second aspect, the present invention provides a dispenser for carbomer gel based compositions comprising: a carbomer gel based composition; at least one component part formed in whole or in part of a polymer/salt mixture, the at least one component part having at least one surface in contact with the carbomer gel based composition during operation of the dispenser; one or more salt crystals located on or in communication with the at least one surface. In one or more embodiments, of this aspect of the present invention the polymer in the polymer/salt mixture further comprises a thermoplastic polymer, thermoset polymer or reaction polymer. In one or more embodiments, the dispenser may include, without limitation, any one or more embodiments of the second aspect of the present invention set forth above wherein the salt in the polymer/salt mixture is selected from the group consisting of sodium chloride, potassium chloride, calcium chloride, and combinations thereof. In one or more embodiments, the dispenser may include, without limitation, any one or more embodiments of the second aspect of the present invention set forth above wherein the polymer in the polymer/salt mixture further comprises a thermoplastic polymer, thermoset polymer or reaction polymer and the salt in the polymer/salt mixture is selected from the group consisting of sodium chloride, potassium chloride, calcium chloride, and combinations thereof.

In one or more embodiments, the dispenser may include, without limitation, any one or more embodiments of the second aspect of the present invention set forth above wherein the at least one component part is selected from the group consisting of nozzles, pump components, guards, and combinations thereof. In one or more embodiments, the dispenser may include, without limitation, any one or more embodiments of the second aspect of the present invention set forth above wherein the polymer/salt mixture contains from about 5% to about 25% salt by weight.

In a third aspect, the present invention provides a method of making a dispenser component that reduces clogging and misdirection in a carbomer gel based fluid dispenser comprising: combining a polymer and a salt to form a polymer/salt mixture; forming a component part of a carbomer gel based fluid dispenser from the polymer/salt mixture, the component part having a surface that will contact the carbomer gel based fluid during operation of the carbomer gel based fluid dispenser; wherein at least some of the salt in the polymer/salt mixture is on or in communication with the surface of the component part.

In one or more embodiments, of this aspect of the present invention polymer further comprises a thermoplastic polymer, thermoset polymer or reaction polymer. In one or more embodiments, the method of making a dispenser component may include, without limitation, any one or more embodiments of the third aspect of the present invention set forth above wherein the polymer is selected from the group consisting of urethane, acrylonitrile butadiene styrene (ABS), polypropylene (PP), high-density polyethylene (HDPE), polyethylene (PE), low-density polyethylene (LDPE), Nylon, polycarbonate (PC), polyethylene terephthalate (PET), high-impact polystyrene (HIPS), urethane, Santoprene®, silicone, polyurethane and combinations thereof.

In one or more embodiments, the method of making a dispenser component may include, without limitation, any one or more embodiments of the third aspect of the present invention set forth above wherein the salt is selected from the group consisting of sodium chloride, potassium chloride, calcium chloride, and combinations thereof. In one or more embodiments, the method of making a dispenser component may include, without limitation, any one or more embodiments of the third aspect of the present invention set forth above wherein the polymer/salt mixture contains from about 5% to about 25% salt by weight.

In one or more embodiments, the method of making a dispenser component may include, without limitation, any one or more embodiments of the third aspect of the present invention set forth above wherein the component part is formed using a process selected from the group consisting of injection molding, compression molding, transfer molding, liquid injection molding, blow molding, over molding, in-mold labeling, and combinations thereof. In one or more embodiments, the method of making a dispenser component may include, without limitation, any one or more embodiments of the third aspect of the present invention set forth above wherein the component part is formed by over molding the polymer/salt mixture into a portion of a preformed component part designed to receive it. In one or more embodiments, the method of making a dispenser component may include, without limitation, any one or more embodiments of the third aspect of the present invention set forth above wherein the component part is selected from the group consisting of nozzles, pumps components, guards, and combinations thereof.

In a fourth aspect, the present invention provides a method for reducing clogging and misdirection in a carbomer gel based fluid dispensers comprising: combining a polymer and a salt to form a polymer/salt mixture; forming a component part of a carbomer gel based fluid dispenser from the polymer/salt mixture, the component part having a surface that will contact the carbomer gel based fluid during operation of the carbomer gel based fluid dispenser; wherein at least some of the salt in the polymer/salt mixture is on or in communication with the surface of the component part; actuating the carbomer gel based fluid dispenser to dispense the carbomer gel based fluid, thereby bringing the carbomer gel based fluid in contact with the salt on or in communication with the surface; reacting the carbomer gel based fluid with the salt, thereby reducing its viscosity. In one or more embodiments, of this aspect of the present invention the polymer may comprises a thermoplastic polymer, thermoset polymer or reaction polymer and the salt and salt is selected from the group consisting of sodium chloride, potassium chloride, calcium chloride, and combinations thereof. In one or more embodiments, the method of making for reducing clogging and misdirection in a carbomer gel based fluid dispensers may include, without limitation, any one or more embodiments of the fourth aspect of the present invention set forth above wherein the polymer/salt mixture contains from about 5% to about 25% salt by weight. In one or more embodiments, the method of making for reducing clogging and misdirection in a carbomer gel based fluid dispensers may include, without limitation, any one or more embodiments of the fourth aspect of the present invention set forth above wherein the component part is formed using a process selected from the group consisting of injection molding, compression molding, transfer molding, liquid injection molding, blow molding, over molding, in-mold labeling and combinations thereof.

Dispenser components made using the polymer/salt mixture of one or more embodiments of the present invention are intended to function (i.e. provide enough electrolytes to reduce the viscosity of the product at the fluid/surface interface) throughout the useful life of the dispenser pump and some unknown time in non-pump components.

### BRIEF DESCRIPTION OF THE DRAWINGS

For a more complete understanding of the features and advantages of the present invention, reference is now made to the detailed description of the invention along with the accompanying figures in which:

FIG. 1 is a graph comparing the time it took for the Purell® Advanced Instant Hand Sanitizer dispensed through a dispensing nozzle to a spot located at the top edge of a urethane plaque to travel to the bottom edge of the plaque or the distance traveled by the Purell® Advanced Instant Hand Sanitizer before stopping short of the bottom edge of the plaque for urethane plaques having 0% and 20% NaCl.

FIG. 2 is a graph comparing the weight of dried Purell® Advanced Instant Hand Sanitizer retained for 50 Å Santoprene® (rough surface) plaques having 0% salt (NaCl) and 10% salt.

FIG. 3 is a graph comparing the time (in seconds) it took for the Purell® Advanced Instant Hand Sanitizer dispensed through a dispensing nozzle to a spot located at the top edge of a sanded polypropylene plaque to travel to the bottom edge of the plaque or the distance traveled by the Purell® Advanced Instant Hand Sanitizer before stopping short of the bottom edge of the plaque for polypropylene plaques having 0%, 10% and 20% NaCl.

FIG. 4 is a graph comparing the weight of dried Purell® Advanced Instant Hand Sanitizer retained for 50 Å silicone plaques having 0% salt (NaCl) and 10% salt.

FIG. 5 is a graph comparing the weight of dried Purell® Advanced Instant Hand Sanitizer retained for 80 Å silicone plaques having 0% salt (NaCl) and 10% salt.

### DETAILED DESCRIPTION OF THE ILLUSTRATIVE EMBODIMENTS

The present invention is directed to dispenser components and related methods that reduce or prevent sticking, drying, buildup, clogging, and/or misdirection of carbomer gel based products such as hand sanitizers. In general outline, a polymer/salt mixture is used to make certain pump and nozzle components and/or inserts of dispensers in such a way as to allow the salt crystals to be exposed or otherwise accessible to the polymer surface. The salt impregnated surface provides electrolytes that reduce the gel viscosity at the fluid/surface interface allowing less residual product to be left on the surface after the dispense has occurred, thereby minimizing clogging of nozzles and misdirected output caused by residual product drying out and clogging or sealing off the fluid pathways.

As used herein, the term “carbomer” or “carbomer gel” refers to a group of cross linked polyacrylic acid polymers commonly used as a rheological modifier to create suspending, stabilizing, or thickening properties in products like hand sanitizers, sunscreens, creams, body lotions, cosmetics, toothpaste, hair products, eye gels, and pain gels, and includes, without limitation, various commercially available products sold by The Lubrizol Company (Wickliffe, Ohio) under the trade name Carbopol.® Accordingly, the terms “carbomer gel based products,” “carbomer gel based fluid,” “carbomer gel based composition,” as used herein, are used interchangeably to refer to any formulation where a carbomer has been used as a rheological modifier to create suspending, stabilizing, or thickening properties, and includes without limitation certain hand sanitizers, sunscreens, creams, body lotions, cosmetics, toothpaste, hair products, eye gels, and pain gels. In some embodiments, the carbomer used in the carbomer gel based products acted upon by dispenser components according to embodiments of the present invention may include, without limitation, Carbopol® Aqua CC Polymer, Carbopol® Ultrez 10 Polymer, Carbopol® Ultrez 20 Polymer, Carbopol® Ultrez 21 Polymer, Carbopol® Ultrez 20 Polymer, Carbopol® EDT 2020 Polymer, Carbopol® EDT 2050 Polymer, Carbopol® 934 Polymer, Carbopol® 940 Polymer, Carbopol® 941 Polymer, Carbopol® 980 Polymer, Carbopol® 981 Polymer, Carbopol® 1342 Polymer, Carbopol® 1382 Polymer, Carbopol® 2984 Polymer, Carbopol® 5984 Polymer, or combinations thereof.

As will be appreciated by those of ordinary skill in the art, before contact with water, the carbomers used in the carbomer gel based products described above are tightly coiled and in the form of a powder. Once the carbomer becomes hydrated by mixing in water, the cross linked polyacrylic acid begins uncoiling. To form the gel used in the carbomer gel based products, the mixture is neutralized with a base, creating negative charges (carboxyl groups) along the backbone of the polymer. Since the negative charges are repulsive, the polymer uncoils further into an extended polymer, thickening the product.

Any polymer having characteristics compatible with use in a dispenser for carbomer gel based products may be used to form the dispenser components of embodiments of the present invention. In some embodiments, a thermoplastic polymer such as acrylonitrile butadiene styrene (ABS), polypropylene (PP), high-density polyethylene (HDPE), polyethylene (PE), low-density polyethylene (LDPE), or polyamides (PA), may be used to form the salt containing component part. In some embodiments, thermoset polymers such as silicones or polyurethanes may be used to form the salt containing component part. In some embodiments, a reaction polymer such as an epoxy or a urethane may be used to form the salt containing component part. As used herein, the term “reaction polymer” refers to any polymer formed by the reaction of two or more materials in the presence of a catalyst. It should be appreciated that in some embodiments, the reaction polymer may also be classified as a thermoplastic polymer or thermoset polymer.

Suitable polymers for forming the salt containing component part may include, without limitation, acrylonitrile butadiene styrene (ABS), polypropylene (PP), high-density polyethylene (HDPE), polyethylene (PE), low-density polyethylene (LDPE), Nylon® (PA), polycarbonate (PC), polyethylene terephthalate (PET), high-impact polystyrene (HIPS), silicone, urethane, Santoprene®, polyurethane, and combinations thereof. As will be appreciated, the polymer chosen for use with a particular component part must also have characteristics suitable for the specific use of that part with in the dispenser. In some embodiments, the component parts are made from silicone. In some embodiments, the component parts are made from ABS and PP.

As used herein the term salt refers to any ionic compound, formed from the neutralization reaction of an acid and a base, that when dissolved in water separates into anions and cations, including without limitation sodium chloride, potassium chloride, calcium chloride, and combinations thereof. Suitable salts are commercially available from a wide range or sources and in a wide range of compositions and configurations. In some embodiments, the salt may be a sodium chloride compound having from about 01% to about 60% sodium and from about 1% to about 60% chloride and may have a density of from about 2.1 g/cc to about 2.6 g/cc. In some embodiments, the salt may comprise about 40% sodium and about 60% chloride. In some embodiments, the salt used may be derived from, for example, kosher salt, table salt, coarse sea salt, fine sea salt, iodized table salt, canning salt, pickling salt, popcorn salt, rock salt, potassium chloride, or combinations thereof. In some embodiments, sodium chloride may be used as the salt and urethane may be used as the polymer.

The concentration of salt in the salt/polymer mixture will vary depending upon the particular application as well as such things as the type of salt used, the size of the salt crystals, the polymer used, and the particular component in which the salt/polymer mixture is to be included. It should be understood that the salt concentration should not be so high as to affect the integrity and other characteristics of the polymer. If the concentration of salt in the salt/polymer mixture is too low, on the other hand, the salt/polymer mixture will not act to reduce or prevent sticking, drying, buildup, clogging, and/or misdirection of carbomer gel based products as intended. In some embodiments, the salt concentration in the salt/polymer mixture may be from about 1% to about 30% by weight. In some embodiments, the salt concentration in the salt/polymer mixture may be from about 5% to about 25% by weight. In some embodiments, the salt concentration in the salt/polymer mixture may be from about 10% to about 20% by weight. In some embodiments, the salt concentration in the salt/polymer mixture may be about 10% by weight. In some embodiments, the salt concentration in the salt/polymer mixture may be about 20% by weight.

The size of the salt crystals in the salt/polymer mixture is not particularly limited provided that the crystals are not so large as to adversely affect the integrity or other necessary characteristics of the polymer. In some embodiments, the salt crystals in the salt polymer mixture may have a diameter of from about 75 μm to about 100 μm. In some embodiments, the salt crystals in the salt polymer mixture may have a diameter of from about 101 μm to about 200 μm. In some embodiments, the salt crystals in the salt polymer mixture may have a diameter larger than about 201.

As set forth above, at least some of the salt contained in the polymer/salt mixture is used to make the component parts and/or inserts for the dispensers must be exposed or otherwise accessible to the polymer surface. In some embodiments, some portion of the salt may be in the form of crystals embedded in and near the surface of the polymer. In some embodiments, the finely ground salt crystals may be used. In some embodiments, the medium ground salt crystals may be used. In some embodiments, the coarsely ground salt crystals may be used.

In some embodiments, it is believed that some of the salt that is close to but not on the surface of the polymer may produce electrolytes that may access the surface of the polymer through cracks and/or channels in the polymer or by dissolving through the polymer to the surface. Such salt, may be described herein as being in communication with the surface of the component or accessible to the surface of the polymer. In some embodiments, the surface of the component part may be abraded to improve access to the surface for the ions in salt crystals trapped near the surface of the component, and to smooth out any rough areas on the surface where the product can collect. In some embodiments, the polymer may be abraded using sandpaper or any another such method known in the art. It should be appreciated, however, that all other things being equal, rougher surfaces provide more surface area for the salt ions to contact the carbomer than smother surfaces. Accordingly, in some embodiments, these rougher surfaces have performed better than comparable smooth surfaces when tested. (See Example 3)

The specific mechanism used to form dispenser component parts comprising the polymer/salt mixture is not particularly limited and will depend upon the characteristics of the particular polymers and salts used and the nature of the component to be formed. Suitable mechanisms may include without limitation, injection molding, compression molding, transfer molding, liquid injection molding, blow molding, over molding, in-mold labeling, and combinations thereof.

Depending upon the mechanism chosen to form the component, the polymer and salt may be combined before or during (or both) the forming process. In some embodiments, the salt may be combined with solid polymer resin (usually in the form of pellets) may be combined and mixed before being added to the machine chosen for forming the component part. In some embodiments, the polymer resin and salt may be combined using a static mixer. In some embodiments, the melted and/or softened polymer resin and salt may be hand mixed. In some of these embodiments, a binding agent may be used to temporarily adhere the salt crystals to the resin as the salt and resin are mixed, keeping the salt from collecting at the bottom of the mixing container and more homogeneously distributing the salt throughout the mixture. Any suitable binding agent known in the art for that purpose may be used and one of ordinary skill in the art will be able to select a binding agent without undue experimentation. Suitable binding agents may include, for example, mineral oil.

In some other embodiments, the salt may be added to a melted and/or softened polymer resin in a separate heated container and mixed for a suitable period of time to ensure thorough mixing of the salt and the polymer prior to the molding or other process for forming the component. In some embodiments, the melted and/or softened polymer resin and salt may be combined using a heated static mixer. In some embodiments, the melted and/or softened polymer resin and salt may be hand mixed. The mixing time will depend upon the amount and types of salt used and the viscosity and other characteristics of the polymer used, but the polymer/salt mixture should be agitated (mixed) until the salt is substantially homogeneously distributed throughout the polymer. Mixing times will, of course, depend upon the quantities of polymer and salt involved but in some embodiments, the polymer/salt mixture may be agitated (mixed) for from about five minutes to about one hour.

In these embodiments, the salt/polymer resin mixture may be fed directly into the molding equipment or processed into solid salt containing polymer pellets or another solid form for later use. As one of ordinary skill on the art will appreciate, the salt should be substantially mixed with the polymer before it becomes too hard, either by cooling or by use of hardeners and the like, and further mixing becomes difficult or impossible.

In some embodiments, a “reaction polymer” formed by the reaction of two or more materials in the presence of a catalyst may be used to form the component. In some embodiments, the polymer resin may have several component parts and the salt may be mixed first with one of the components before all of the components are combined and mixed to form the polymer that will be used to create the component part. In some embodiments, the components of the polymer may include such things as a hardener, a catalyst, and/or a crosslinking agent.

As the melting point of salt is ordinarily significantly higher than the melting point of the resin being used, it is believed that the salt crystals dispersed throughout the molded polymer will have substantially the same size and shape as when they were added to the resin. In an alternative embodiment, however, a resin with a melting point higher than that of the salt may be used. It is believed that in these embodiments the salt will melt and become more homogeneously distributed within the polymer.

If the component is to be made by traditional injection molding or liquid injection molding processes, for example, the salt may be mixed with the base resin as the resin enters the barrel of the injection molding machine and as the resin moves through the screw section the salt mixes with the resin to form a homogeneous mixture. If the component is to be transfer molded, however, the salt may, in some embodiments, be introduced into the base material during the material mixing process or prior to introducing the material to the mold. As the mixture is transferred into the mold the homogeneous mixture fills the mold cavity and cools to from a solid component.

In some embodiments, a chilled mold may be used. It is believed that use of a chilled mold will tend to bring more of the salt to or near the surface of the molded component.

While the polymer/salt mixture may be used to create any component part of the dispenser, it is envisioned that the use of the polymer/salt mixture be limited to those component parts that contact the carbomer gel based product during the ordinary use of the dispenser. The polymer/salt mixture should not, however, be used in so many components or contain so much salt as to significantly decrease the overall viscosity the product stored in the dispenser. The particular dispenser component parts involved will, of course, depend upon the design of the dispenser but may include without limitation the nozzle, any pump components, and/or guards used to limit the discharge orientation of product from the dispenser. In some embodiments, the polymer/salt mixture may be used to create the nozzle. In some embodiments, the polymer/salt mixture may be used to create the pathway from the pump to the nozzle. In some embodiments, the polymer/salt mixture may be used to create pump parts prone to clogging.

Moreover, it is not required that the entire component part be made from the polymer/salt mixture, where only a portion of the part contacts the carbomer gel based product. In some embodiments, only a portion of the component part is made from the polymer/salt mixture. In some embodiments, the polymer/salt mixture may be molded into an insert to be placed into or attached to an area of the component part prepared to receive it. In some embodiments, a small polymer/salt mixture component may be molded and assembled onto a primary assembly of the pump, nozzle or dispenser. In some embodiments, the polymer/salt mixture may be used to create a small inset located at the end of the nozzle.

In some embodiments, the polymer/salt mixture may be over molded into an area of the component part prepare to receive it using any process known the art for that purpose. In some embodiments, the polymer/salt mixture may be over molded into an area of a recessed area at the end of the nozzle. In some embodiments, a subcomponent comprising the salt/polymer mixture may be added to a larger component using in-mold labeling techniques. In these embodiments, the subcomponent is held to the inner surface of the empty mold by electrostatic or other methods, as the larger component is molded. In these embodiments, the subcomponent comprising the salt/polymer mixture becomes molded into the surface of the larger component.

In some embodiments, two injection ports, one containing polymer/salt mixture and the other an ordinary polymer, may be used to form a component having a surface comprising the polymer/salt mixture. In these embodiments, the injection ports and/or mold are oriented in such a way that the salt/polymer mixture will be isolated and/or concentrated in a desired part of the mold when the mold is injected.

In some other embodiments, the polymer/salt mixture may be applied to some or all of the surfaces of the component part as a coating. In some embodiments, the polymer/salt mixture may be sprayed onto the surface of a component part prepared to receive it.

As will be appreciated by those of skill in the art, the carbomer gel based products will contain water in which the salt on, or in communication with, the surface of the polymer is soluble. And as set forth above, as electrolyte concentration from the salt dissolving into the gelled carbomer product goes up, it begins to bridge the repulsive forces between the carboxylic acid groups in the carbomer gel. This allows the carbomer polymer to collapse on itself, thereby breaking the gel form and returning it to its liquid state. And because this is occurring at the fluid/surface interface, it creates what amounts to a “non-stick” surface, as the gel moves over a thin film of liquefied carbomer on the surface. Accordingly, it is believed that the residual product in contact with the polymer/salt mixture will then slide either out the end of the nozzle or back into the dispenser, thereby reducing the amount of residue that can collect on the surface and reducing or eliminating the associated sticking, drying, buildup, clogging, and/or misdirection of the product.

This is borne out by Examples 1-8 below which demonstrate that the dispenser and dispenser components of embodiments of the present invention, dramatically reduces the ability of carbomer gel based compositions to dry, harden and/or collect in ways associated with sticking, drying, buildup, clogging, and/or misdirection of the product, when compared to such polymers without the salt. While some reduction was anticipated, the degree by which the polymer/salt mixture of embodiments of the present invention may reduce the ability of carbomer gel based compositions to dry, harden and/or collect in ways associated with sticking, drying, buildup, clogging, and/or misdirection of the product, as well as the duration of the effect, were unexpected and constitute a significant breakthrough.

In light of the foregoing, it should be appreciated that the present invention significantly advances the art by providing dispensers and/or dispenser components that are structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### EXAMPLES

The following examples are offered to more fully illustrate the invention, but are not to be construed as limiting the scope thereof. Further, while some of examples may include conclusions about the way the invention may function, the inventor do not intend to be bound by those conclusions, but put them forth only as possible explanations. Moreover, unless noted by use of past tense, presentation of an example does not imply that an experiment or procedure was, or was not, conducted, or that results were, or were not actually obtained. Efforts have been made to ensure accuracy with respect to numbers used (e.g., amounts, temperature), but some experimental errors and deviations may be present. Unless indicated otherwise, parts are parts by weight, molecular weight is weight average molecular weight, temperature is in degrees Centigrade, and pressure is at or near atmospheric.

### Example 1

### Formation of the Salt/Urethane Mixture

In order to evaluate the effect of a salt/polymer mixture on carbomer-based products such as hand sanitizers, a series of 10 4 inch by 4 inch urethane test plaques were formed using having a salt concentration of 20% and 10 control plaques (without salt) were prepared by cast molding. The test plaques were prepared by using Hapflex™ 500 Series polyurethane elastomer made by mixing a Part A compound, comprising the bulk resin and a Part B compound comprising a curing agent. The Part B compound was mixed with an appropriate amount of table salt to form a substantially homogeneous mixture before it was mixed with the Part A compound (resin) according to the manufacturer's instructions, to form a substantially homogeneous polyurethane elastomer/salt mixture having a salt concentration of about 20% by weight. The polyurethane/salt mixture was then poured into horizontally oriented 4 inch×4 inch open air molds, where it cooled to form solid 4 inch×4 inch polyurethane plaques having a 20% salt content.

The control plaques were prepared using substantially the same process except that the salt was not added.

The plaques had an opaque white/yellow color and were allowed to state 24 hours before testing. It was determined that for consistency, the side of the plaque facing the bottom of the mold (the “bottom” side) would be the side to be tested and the plaques were evenly sanded using uniform pressure on the bottom side using 220 grit sandpaper twenty swipes in each direction

### Example 2

### Formation of the Salt/Polymer Mixture

In these experiments, the effect of differing concentrations of salt in a salt/polymer mixture on carbomer-based products such as hand sanitizers was evaluated using the 4 inch by 4 inch urethane/salt plates described in Example 1.

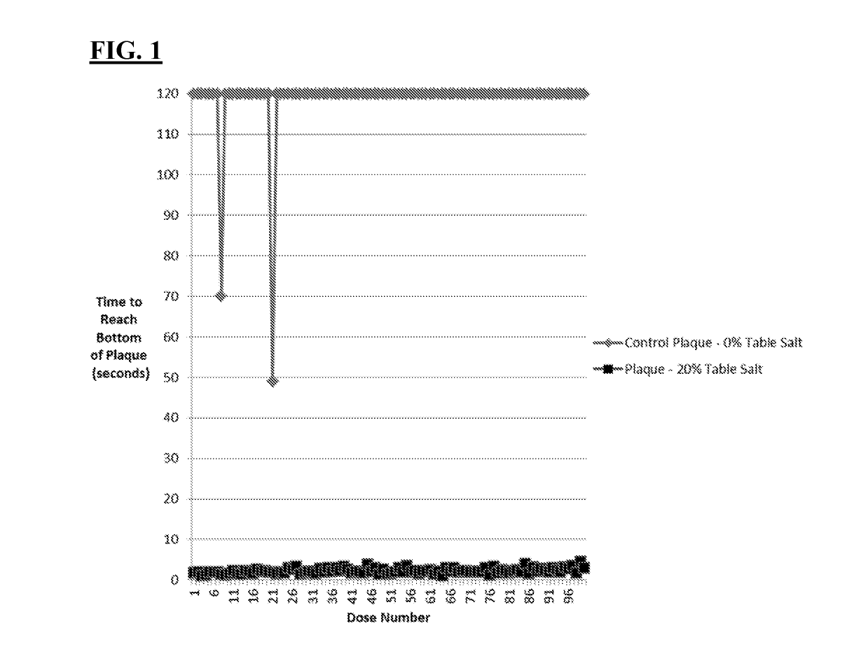

Each of the 4 inch by 4 inch urethane/salt plaques described in Example 1 were placed on a test rack designed to rotate from a horizontal position to an angle of at least 45 degrees. The plaques were placed in a horizontal orientation and approximately 0.5 mL Purell® Advanced Instant Hand Sanitizer was dispensed through a dispensing nozzle to a spot located at the top edge of each of the plaques. The rack was then rotated to place the plaque at a 45 degree angle to the horizontal and the time it took for the Purell® Advanced Instant Hand Sanitizer to travel to the bottom edge of the plaque or the distance traveled by the Purell® Advanced Instant Hand Sanitizer before stopping short of the bottom edge of the plaque were recorded. The flow of the Purell® Advanced Instant Hand Sanitizer down the plaque was deemed to have stopped when it failed to move more than ¼inch in 120 seconds. The product was then allowed to dry and in 20 minutes the test was repeated. A total of ten dispenses were completed for each plaque. A total of 10 test plaques having 20% salt content and 10 control plaques having no salt added were tested. The results for each plaque are set forth in Tables 1 and 2 below and shown in FIG. 1.

TABLE 1
Control Plaques - 0% Table Salt

| | | | Time to Reach | Distance from Start |
|---|---|---|---|---|
| | Dose | Dose | Bottom of | Position to End |
| Plaque | Number | Size (mL) | Plaque (seconds) | Position (inches) |
| A | 1 | 0.5 | 120.00 | 0.25 |
| | 2 | | 120.00 | 1.45 |
| | 3 | | 120.00 | 0.57 |
| | 4 | | 120.00 | 0.95 |
| | 5 | | 120.00 | 1.09 |
| | 6 | | 120.00 | 0.34 |
| | 7 | | 120.00 | 0.72 |
| | 8 | | 70.00 | bottom |
| | 9 | | 120.00 | 0.34 |
| | 10 | | 120.00 | 0.66 |
| B | 11 | 0.5 | 120.00 | 0.59 |
| | 12 | | 120.00 | 0.38 |
| | 13 | | 120.00 | 0.14 |
| | 14 | | 120.00 | 0.22 |
| | 15 | | 120.00 | 0.20 |
| | 16 | | 120.00 | 0.27 |
| | 17 | | 120.00 | 0.36 |
| | 18 | | 120.00 | 1.26 |
| | 19 | | 120.00 | 0.42 |
| | 20 | | 120.00 | 0.74 |
| C | 21 | 0.5 | 49.00 | bottom |
| | 22 | | 120.00 | 1.40 |
| | 23 | | 120.00 | 0.50 |
| | 24 | | 120.00 | 0.23 |
| | 25 | | 120.00 | 0.55 |
| | 26 | | 120.00 | 0.67 |
| | 27 | | 120.00 | 0.17 |
| | 28 | | 120.00 | 0.20 |
| | 29 | | 120.00 | 0.35 |
| | 30 | | 120.00 | 0.74 |
| D | 31 | 0.5 | 120.00 | 0.30 |
| | 32 | | 120.00 | 0.42 |
| | 33 | | 120.00 | 0.42 |
| | 34 | | 120.00 | 0.24 |
| | 35 | | 120.00 | 0.20 |
| | 36 | | 120.00 | 0.22 |
| | 37 | | 120.00 | 0.70 |
| | 38 | | 120.00 | 0.21 |
| | 39 | | 120.00 | 0.57 |
| | 40 | | 120.00 | 0.50 |
| E | 41 | 0.5 | 120.00 | 0.30 |
| | 42 | | 120.00 | 0.22 |
| | 43 | | 120.00 | 0.34 |
| | 44 | | 120.00 | 0.28 |
| | 45 | | 120.00 | 0.18 |
| | 46 | | 120.00 | 0.31 |
| | 47 | | 120.00 | 0.36 |
| | 48 | | 120.00 | 0.20 |
| | 49 | | 120.00 | 0.67 |
| | 50 | | 120.00 | 0.69 |
| F | 51 | 0.5 | 120.00 | 3.30 |
| | 52 | | 120.00 | 0.40 |
| | 53 | | 120.00 | 0.21 |
| | 54 | | 120.00 | 0.26 |
| | 55 | | 120.00 | 0.33 |
| | 56 | | 120.00 | 0.24 |
| | 57 | | 120.00 | 0.23 |
| | 58 | | 120.00 | 0.27 |
| | 59 | | 120.00 | 0.28 |
| | 60 | | 120.00 | 0.26 |
| G | 61 | 0.5 | 120.00 | 0.33 |
| | 62 | | 120.00 | 0.44 |
| | 63 | | 120.00 | 0.50 |
| | 64 | | 120.00 | 0.32 |
| | 65 | | 120.00 | 0.30 |
| | 66 | | 120.00 | 0.26 |
| | 67 | | 120.00 | 0.18 |
| | 68 | | 120.00 | 0.20 |
| | 69 | | 120.00 | 0.34 |
| | 70 | | 120.00 | 0.44 |
| H | 71 | 0.5 | 120.00 | 0.18 |
| | 72 | | 120.00 | 0.47 |
| | 73 | | 120.00 | 0.25 |
| | 74 | | 120.00 | 0.29 |
| | 75 | | 120.00 | 0.38 |
| | 76 | | 120.00 | 0.35 |
| | 77 | | 120.00 | 0.23 |
| | 78 | | 120.00 | 0.13 |
| | 79 | | 120.00 | 0.47 |
| | 80 | | 120.00 | 0.45 |
| J | 81 | 0.5 | 120.00 | 0.57 |
| | 82 | | 120.00 | 0.37 |
| | 83 | | 120.00 | 0.39 |
| | 84 | | 120.00 | 0.42 |
| | 85 | | 120.00 | 0.24 |
| | 86 | | 120.00 | 0.24 |
| | 87 | | 120.00 | 0.25 |
| | 88 | | 120.00 | 0.40 |
| | 89 | | 120.00 | 0.33 |
| | 90 | | 120.00 | 0.56 |
| K | 91 | 0.5 | 120.00 | 0.23 |
| | 92 | | 120.00 | 0.29 |
| | 93 | | 120.00 | 0.26 |
| | 94 | | 120.00 | 0.25 |
| | 95 | | 120.00 | 0.24 |
| | 96 | | 120.00 | 0.34 |
| | 97 | | 120.00 | 0.23 |
| | 98 | | 120.00 | 0.18 |
| | 99 | | 120.00 | 0.30 |
| | 100 | | 120.00 | 0.48 |

TABLE 2
Test Plaques - 20% Table Salt

| | | | Time to Reach | Distance from Start |
|---|---|---|---|---|
| | Dose | Dose | Bottom of | Position to End |
| Plaque | Number | Size (mL) | Plaque (seconds) | Position (inches) |
| L | 1 | 0.5 | 1.72 | bottom |
| | 2 | | 1.9 | bottom |
| | 3 | | 1.02 | bottom |
| | 4 | | 1.2 | bottom |
| | 5 | | 2 | bottom |
| | 6 | | 1.97 | bottom |
| | 7 | | 2 | bottom |
| | 8 | | 1.5 | bottom |
| | 9 | | 1.2 | bottom |
| | 10 | | 1.64 | bottom |
| M | 11 | 0.5 | 2.26 | bottom |
| | 12 | | 1.59 | bottom |
| | 13 | | 1.51 | bottom |
| | 14 | | 2.28 | bottom |
| | 15 | | 2.2 | bottom |
| | 16 | | 1.63 | bottom |
| | 17 | | 2.63 | bottom |
| | 18 | | 2.08 | bottom |
| | 19 | | 2.32 | bottom |
| | 20 | | 2.02 | bottom |
| N | 21 | 0.5 | 2 | bottom |
| | 22 | | 1.69 | bottom |
| | 23 | | 1.89 | bottom |
| | 24 | | 1.77 | bottom |
| | 25 | | 3 | bottom |
| | 26 | | 2.6 | bottom |
| | 27 | | 3.26 | bottom |
| | 28 | | 1.39 | bottom |
| | 29 | | 1.84 | bottom |
| | 30 | | 2.06 | bottom |
| O | 31 | 0.5 | 2.09 | bottom |
| | 32 | | 1.56 | bottom |
| | 33 | | 2.9 | bottom |
| | 34 | | 1.9 | bottom |
| | 35 | | 3 | bottom |
| | 36 | | 2.21 | bottom |
| | 37 | | 3.03 | bottom |
| | 38 | | 2.25 | bottom |
| | 39 | | 3.3 | bottom |
| | 40 | | 2.7 | bottom |
| P | 41 | 0.5 | 1.78 | bottom |
| | 42 | | 2.15 | bottom |
| | 43 | | 2.15 | bottom |
| | 44 | | 1.76 | bottom |
| | 45 | | 3.8 | bottom |
| | 46 | | 2.19 | bottom |
| | 47 | | 3.03 | bottom |
| | 48 | | 1.52 | bottom |
| | 49 | | 2.57 | bottom |
| | 50 | | 1.5 | bottom |
| Q | 51 | 0.5 | 1.57 | bottom |
| | 52 | | 1.94 | bottom |
| | 53 | | 3 | bottom |
| | 54 | | 2.03 | bottom |
| | 55 | | 3.59 | bottom |
| | 56 | | 2 | bottom |
| | 57 | | 2.33 | bottom |
| | 58 | | 1.62 | bottom |
| | 59 | | 2.38 | bottom |
| | 60 | | 2.16 | bottom |
| R | 61 | 0.5 | 2.45 | bottom |
| | 62 | | 1.45 | bottom |
| | 63 | | 2.06 | bottom |
| | 64 | | 1.09 | bottom |
| | 65 | | 3 | bottom |
| | 66 | | 2.08 | bottom |
| | 67 | | 3 | bottom |
| | 68 | | 1.95 | bottom |
| | 69 | | 2.25 | bottom |
| | 70 | | 2.25 | bottom |
| S | 71 | 0.5 | 2.01 | bottom |
| | 72 | | 2.03 | bottom |
| | 73 | | 2.14 | bottom |
| | 74 | | 2 | bottom |
| | 75 | | 3 | bottom |
| | 76 | | 1.35 | bottom |
| | 77 | | 3.4 | bottom |
| | 78 | | 1.81 | bottom |
| | 79 | | 2.39 | bottom |
| | 80 | | 2.27 | bottom |
| T | 81 | 0.5 | 1.78 | bottom |
| | 82 | | 2.13 | bottom |
| | 83 | | 2.51 | bottom |
| | 84 | | 1.88 | bottom |
| | 85 | | 4 | bottom |
| | 86 | | 1.63 | bottom |
| | 87 | | 3.25 | bottom |
| | 88 | | 2.07 | bottom |
| | 89 | | 2.78 | bottom |
| | 90 | | 2.35 | bottom |
| U | 91 | 0.5 | 2 | bottom |
| | 92 | | 3 | bottom |
| | 93 | | 2.45 | bottom |
| | 94 | | 1.9 | bottom |
| | 95 | | 3.2 | bottom |
| | 96 | | 2.76 | bottom |
| | 97 | | 3.56 | bottom |
| | 98 | | 1.84 | bottom |
| | 99 | | 4.5 | bottom |
| | 100 | | 2.97 | bottom |

As can be seen in FIG. 1, which compares the time it took the Purell® Advanced Instant Hand Sanitizer to reach the bottom edge of the plaque for the Control plaques (A-K) to the plaques having a 20% salt concentration (l-U), the plaques made with the polymer/salt mixture of the present invention demonstrated a substantial improvement in the ability of the Purell® Advanced Instant Hand Sanitizer to flow off of the plaque. It is believed that this improvement reflects the non-stick effect resulting from the salt dissolving into the carbomer solution and substantially reducing the viscosity of the gel form at the surface to fluid interface, permitting the product to slide off of the plaque thereby reducing the amount of residue that can collect on the surface.

### Example 3

### Formation of the Salt/Santoprene® Mixture

Pellets of Santoprene® 8211-55 polymer were combined with fine powder salt (NaCl, grain size 75-212 μm) and mineral oil (as a binding agent) in a container such that the salt comprised 10% of the mixture by weight. The mixture was manually mixed for about 5-10 minutes to evenly distribute the salt throughout before being added to an injection molding machine. The mixture was then injected into a series of 5 inch by 6 inch molds, forming plaques of Santoprene® 8211-55 polymer having 10% NaCl by weight. These plaques had a rough side (mold finish=MT1055) and a smother side (mold finish=SPI C3).

Comparable Santoprene® 8211-55 polymer control plaques were prepared using substantially the same process except that the salt was not added.

### Example 4

### Testing of the Salt/Santoprene® Mixture

The mass of two Santoprene® 8211-55 polymer plaques of Example 3 having 10% NaCl and two Santoprene® 8211-55 polymer control plaques were recorded and the plaques mounted on an Auto Pumper at 90 degrees to the horizontal (completely vertical). The plaques were oriented so that each group (0% and 10% salt) had a one plaque with the rough side out and one plaque with the smooth side out. A 12 Fl-oz table top dispenser of Purell® Advanced Instant Hand Sanitizer is held a short distance away from the plaques and set up on the auto pumper such that when pumped the PURELL Advanced is shot onto the top of the sample plaque, and allowed to run down into a catch basin.

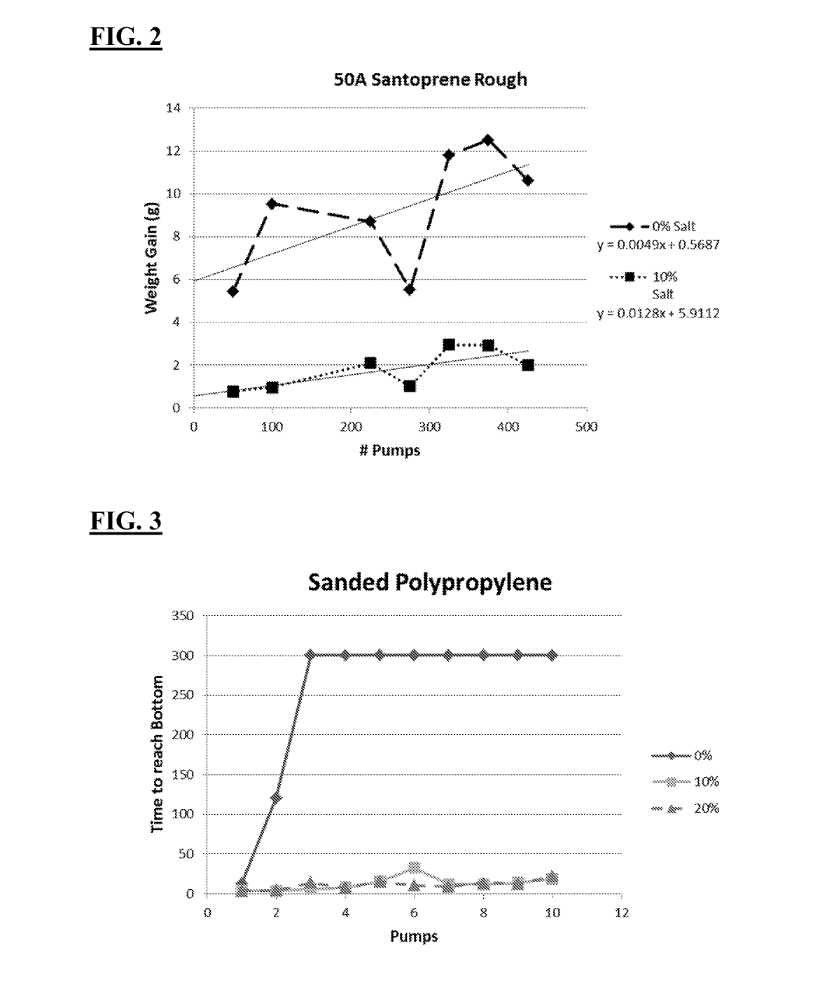

The dispenser was depressed completely in 0.75 seconds, dispensing approximately 1 ml of Purell® Advanced Instant Hand Sanitizer once every 30 minutes. Every approximately 24 hours, the total number of dispenses (pumps) and the weight of each of the plaques were recorded (10 minutes after the latest pump). The mass recorded was subtracted from the mass of the sample at 0 pumps, so that the result is the mass of the PURELL Advanced on the plaque. The test was ended after approximately 425 pumps. The experiments were conducted at room temperature. The data is reported on Table 3 below and shown in FIG. 2.

TABLE 3

| | | Weight Gain (g) |
|---|---|---|
| Salt Level | Surface | after 50 pumps |
| 0% | Rough | 5.4342 |
| 0% | Smooth | 4.2643 |
| 10% | Rough | 0.7638 |
| 10% | Smooth | 2.9922 |

Both plaques containing 10% salt showed a substantial reduction of accumulated carbomer residue when compared to the control plaques. The reduction for the 10% Rough plaque was particularly significant, dropping from 4.2643 g to just 0.7638 g. It is believed that this substantial reduction in carbomer residue would result in a corresponding reduction in sticking, drying, buildup, clogging, and/or misdirection of the product.

### Example 5

### Formation of the Salt/Polypropylene Mixture

Pellets of polypropylene polymer (Braskem PP D115A) were combined with fine powder salt (NaCl, grain size 75-212 μm) and mineral oil (as a binding agent) in a container such that the salt comprised 10% of the mixture by weight. The mixture was manually mixed for about 5-10 minutes to evenly distribute the salt throughout before the mixture was transferred to an injection molding machine and the plaques formed. This process was repeated but the weight percentage of NaCl increased to 20%.

Each polypropylene/NaCl mixture was then injected into a series of 5 inch by 6 inch molds, forming plaques of polypropylene polymer having 10% and 20% NaCl by weight. Comparable polypropylene polymer control plaques were prepared using substantially the same process except that the salt was not added.

### Example 6

### Testing of the Salt/Polypropylene Mixture

Polypropylene plaques formed as set forth in Example 5 above, having 0%, 10%, and 20% NaCl were abraded using a sanding block with 100 grit sand paper for 100 strokes. A test rig was constructed where the samples could be placed horizontal and PURELL Advanced Hand Sanitizer placed on the top of the sample. The rig could then be flipped so that the plaques were held at an angle of 45 degrees to horizontal.

Polypropylene plaques having 0%, 10%, and 20% NaCl were each placed in the rig in the horizontal position. 0.2 mL of PURELL Advanced was placed as a blob at the top in the center of the sample using a syringe. The location where the PURELL Advanced was placed was marked so that repeated experiments could be started in the same spot every time. The samples were then flipped to an angle of 45 degrees to the horizontal and a timer was started (when the sample flipped). The timer was stopped when the PURELL Advanced blob reached the bottom of the plaque, or after 5 minutes if the PURELL Advanced did not reach a failure was noted. The test was repeated every 30 minutes for approximately 5 hours. The experiments were conducted at room temperature.

The number of tests done on the same spot was recorded as well as the time on the timer. The test was repeated in the same spot to show the results would not diminish after repeated use. The data is shown in FIG. 3 and clearly demonstrates a substantial improvement in the ability of the Purell® Advanced Instant Hand Sanitizer to flow off of the plaque for the plaques made with the 10% and 20% polymer/salt mixture of the present invention compared to the control plaques. As in Example 2, it is believed that this improvement reflects the non-stick effect resulting from the salt dissolving into the carbomer solution and substantially reducing the viscosity of the gel form at the surface to fluid interface, permitting the product to slide off of the plaque thereby reducing the amount of residue that can collect on the surface.

### Example 7

### Formation of the Salt/Silicone Mixture

Fine powder salt (NaCl, grain size 75-212 μm) was manually mixed into raw uncured (50 shore A durometer) Dow gum base silicone for about 5-10 minutes to evenly distribute the salt throughout and peroxide was added as a curing agent. Small piece of uncured silicone with salt were cut from the mixture and compression molded into cured 50 shore A durometer silicone plaques approximately 6 in by 6 in in size.

The same process was repeated using raw uncured (80 shore A durometer) silicone to make approximately 5 inch by 6 inch cured 80 shore A durometer silicone plaques. Comparable 50 shore A durometer silicone and 80 shore A durometer silicone polymer control plaques were prepared using substantially the same process except that the salt was not added.

### Example 8

### Testing of the Salt/Silicone Mixture

The mass of the 50 shore A durometer silicone and 80 shore A durometer silicone polymer plaques of Example 7 having 10% NaCl and two control plaques were recorded. Each of the plaques was then mounted on an Auto Pumper at 90 degrees to the horizontal (completely vertical). A 12 Fl-oz table top dispenser of Purell® Advanced Instant Hand Sanitizer is held a short distance away from the plaques and set up on the auto pumper such that when pumped the PURELL Advanced is shot onto the top of the sample plaque, and allowed to run down into a catch basin. The experiments were conducted at room temperature.

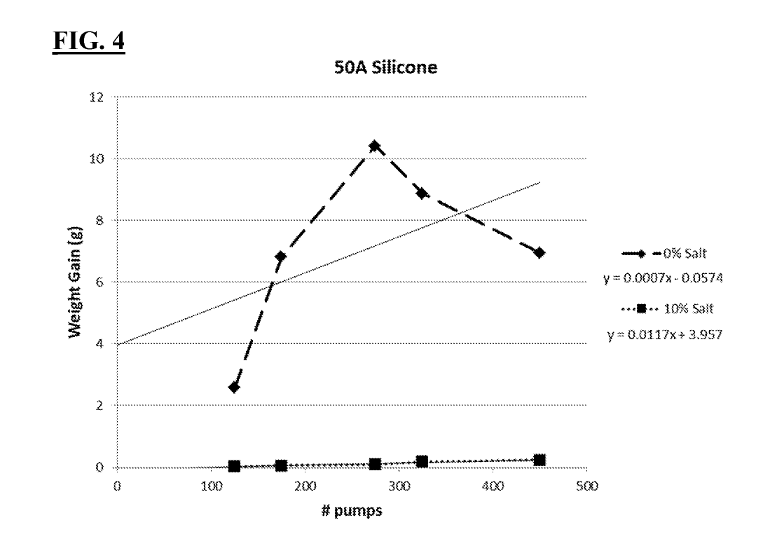

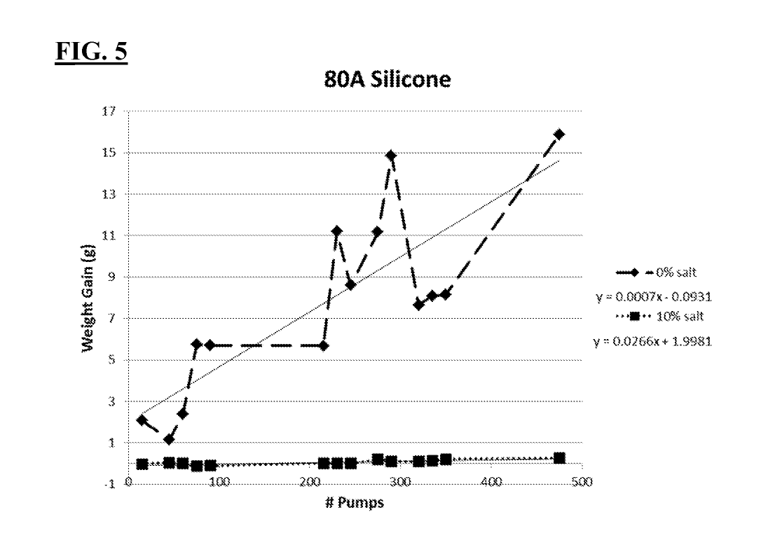

The dispenser was depressed completely in 0.75 seconds, dispensing approximately 1 ml of Purell® Advanced Instant Hand Sanitizer once every 30 minutes. Every approximately 24 hours, the total number of pumps dispenses and the weights of the plaque were recorded (10 minutes after the latest pump). The mass recorded was subtracted from the mass of the sample at 0 pumps, so that the result is the mass of the PURELL Advanced on the plaque. The test was ended after approximately 450 pumps for the 50 shore A durometer silicone plaques and approximately 475 pumps for the 80 shore A durometer silicone plaques. The data is shown in FIGS. 4 and 5, which show a near elimination of accumulated carbomer residue for both the 50 shore A durometer silicone plaques (FIG. 4) and the 80 shore A durometer silicone plaques (FIG. 5) when compared to the control plaques. These results were unexpectedly positive and reflect as much as a 10 fold reduction in residual (dried, hardened) carbomer gel for the 50 shore A durometer silicone plaques (FIG. 4) and as much as a 16 fold reduction in the same for the 80 shore A durometer silicone plaques (FIG. 5). It is believed that this substantial reduction in carbomer residue would result in a corresponding reduction in sticking, drying, buildup, clogging, and/or misdirection of the product.

What is claimed is:

1. A dispenser component configured for use in a dispenser for carbomer gel based compositions, said dispenser component comprising:
at least one surface configured to be in contact with a carbomer gel based composition when it is being dispensed, and
a plurality of salt crystals located on or in communication with said surface.

2. The dispenser component of claim 1 wherein some or all of said dispenser component comprises a polymer/salt mixture.

3. The dispenser component of claim 2 wherein said polymer further comprises a thermoplastic polymer, thermoset polymer or reaction polymer.

4. The dispenser component of claim 2 wherein said polymer is selected from the group consisting of acrylonitrile butadiene styrene (ABS), polypropylene (PP), high-density polyethylene (HDPE), polyethylene (PE), low-density polyethylene (LDPE), Nylon®, polycarbonate (PC), polyethylene terephthalate (PET), high-impact polystyrene (HIPS), urethane, Santoprene®, silicone, polyurethane, and combinations thereof.

5. The dispenser component of claim 1 wherein said plurality salt crystals are selected from the group consisting of sodium chloride, potassium chloride, calcium chloride, and combinations thereof.

6. The dispenser component of claim 2 wherein said polymer/salt mixture contains from about 5% to about 25% salt by weight.

7. The dispenser component of claim 1 wherein said dispenser component is selected from the group consisting of nozzles, pump components, guards, and combinations thereof.

8. A dispenser for carbomer gel based compositions comprising:
a carbomer gel based composition;
at least one component part formed in whole or in part of a polymer/salt mixture, said at least one component part having at least one surface in contact with said carbomer gel based composition during operation of the dispenser;
one or more salt crystals located on or in communication with said at least one surface.

9. The dispenser of claim 8 wherein the polymer in said polymer/salt mixture further comprises a thermoplastic polymer, thermoset polymer or reaction polymer and the salt in said polymer/salt mixture is selected from the group consisting of sodium chloride, potassium chloride, calcium chloride, and combinations thereof.

10. The dispenser of claim 8 wherein said at least one component part is selected from the group consisting of nozzles, pump components, guards, and combinations thereof.

11. The dispenser of claim 8 wherein said polymer/salt mixture contains from about 5% to about 25% salt by weight.

12. A method of making a dispenser component that reduces clogging and misdirection in a carbomer gel based fluid dispenser comprising:
combining a polymer and a salt to form a polymer/salt mixture;
forming a component part of a carbomer gel based fluid dispenser from said polymer/salt mixture, said component part having a surface that will contact the carbomer gel based fluid during operation of said carbomer gel based fluid dispenser;
wherein at least some of the salt in said polymer/salt mixture is on or in communication with the surface of said component part.

13. The method of claim 12 wherein said polymer further comprises a thermoplastic polymer, thermoset polymer or reaction polymer

14. The method of claim 12 wherein said polymer is selected from the group consisting of urethane, acrylonitrile butadiene styrene (ABS), polypropylene (PP), high-density polyethylene (HDPE), polyethylene (PE), low-density polyethylene (LDPE), Nylon, polycarbonate (PC), polyethylene terephthalate (PET), high-impact polystyrene (HIPS), urethane, Santoprene®, silicone, and combinations thereof.

15. The method of claim 12 wherein said salt is selected from the group consisting of sodium chloride, potassium chloride, calcium chloride, and combinations thereof.

16. The method of claim 12 wherein said polymer/salt mixture contains from about 5% to about 25% salt by weight.

17. The method of claim 12 wherein the component part is formed using a process selected from the group consisting of injection molding, compression molding, transfer molding, liquid injection molding, blow molding, over molding, in-mold labeling, and combinations thereof.

18. The method of claim 12 wherein said component part is formed by over molding said polymer/salt mixture into a portion of a preformed component part designed to receive it.

19. The method of claim 12 wherein said component part is selected from the group consisting of nozzles, pumps components, guards, and combinations thereof.

20. A method for reducing clogging and misdirection in a carbomer gel based fluid dispenser comprising:
combining a polymer and a salt to form a polymer/salt mixture;
forming a component part of a carbomer gel based fluid dispenser from said polymer/salt mixture, said component part having a surface that will contact the carbomer gel based fluid during operation of said carbomer gel based fluid dispenser; wherein at least some of the salt in said polymer/salt mixture is on or in communication with the surface of said component part;
actuating said carbomer gel based fluid dispenser to dispense said carbomer gel based fluid, thereby bringing said carbomer gel based fluid in contact with the salt on or in communication with said surface;
reacting said carbomer gel based fluid with said salt, thereby reducing its viscosity.

21. The method of claim 20 wherein said polymer comprises a thermoplastic polymer, thermoset polymer or reaction polymer and said salt and salt is selected from the group consisting of sodium chloride, potassium chloride, calcium chloride, and combinations thereof.

22. The method of claim 20 wherein said polymer/salt mixture contains from about 5% to about 25% salt by weight.

23. The method of claim 20 wherein the component part is formed using a process selected from the group consisting of injection molding, compression molding, transfer molding, liquid injection molding, blow molding, over molding, in-mold labeling, and combinations thereof.
